(19) United States
(12) Patent Application Publication
(10) Pub. No.: US 2010/0244543 A1
(43) Pub. Date: Sep. 30, 2010

(54) Harness Buckle and Chest Clip Release

(75) Inventors: Rachel Fine, West Chester, PA (US); Patrick W. Laffan, Berwyn, PA (US)

Correspondence Address: Lempia Braidwood Graco, One North LaSalle Street Suite 3150, Chicago, IL, 60602, US

(73) Assignee: Graco Children's Products Inc., Exton, PA (US)

(21) Appl. No.: 12/412,288

(22) Filed: Mar. 26, 2009

(51) Int. Cl. A47D 15/00; A62B 35/00

(52) U.S. Cl. 297/484

(57) ABSTRACT

A child seat harness system has first and second lap belt straps extendable generally toward one another. A buckle assembly of the system has first and second buckle connectors each coupled to the respective first and second lap belt straps. The buckle assembly is positioned and configured to releasably latch the first and second lap belt straps at the buckle assembly. The system has a release mechanism that is configured, when actuated, to detach the first and second buckle sections at the buckle assembly. The system also has first and second shoulder straps extending collaterally up and away from the buckle assembly. A chest clip has two clip sections, one each coupled to a respective one of the first and second shoulder straps. The two clip sections are configured to releasably engage one another and are positioned above the buckle assembly. The release mechanism also disengages the two clip sections from one another when actuated.

### BACKGROUND OF THE INVENTION

1. Field of the Disclosure

The present disclosure is generally directed to children's vehicle seats and more particularly to a harness or restraint system with a buckle assembly and a chest clip that both release upon actuation of the same release actuator.

2. Description of Related Art

A conventional child safety seat such as an infant carrier or toddler seat often comes with a restraint or harness system having a buckle assembly and a chest clip. The harness system of such seats often has a crotch belt extending up from or relative to the seat bottom and a portion of a buckle assembly on the free end of the crotch strap. These conventional seats also typically include a lap belt strap extending up from each of the opposed sides of the seat. Each lap belt strap is equipped with another portion of the buckle assembly that can engage the buckle portion on the crotch strap. These typical harness systems also employ shoulder harness straps that extend down over the shoulders of a seat occupant. The shoulder straps may include a separate buckle portion that can also connect to the crotch strap portion. However, the shoulder straps are often a continuation of the respective lap belt straps and share a common buckle assembly portion that connects to the crotch strap portion.

A typical harness system on car seats in the United States often employs a chest clip on the shoulder harnesses. The chest clip is spaced upward from the buckle assembly and functions completely independently. The chest clip typically has two clip sections, one on each shoulder strap, that can engage one another and hold the shoulder straps closely spaced to one another. The chest clip is also typically slidable up and down the shoulder straps to accommodate children of different height. The chest clip thus holds the straps close to one another and can be positioned vertically along the straps to assist in keeping the shoulder straps properly positioned over the shoulders of a child seated in the seat.

On a typical harness system, the buckle assembly and the chest clip are released independent of one another. Each device includes its own separate release actuator on the device. Thus, if a caregiver wishes to remove their child from the seat, they must independently release both the buckle assembly and the chest clip, which requires two separate steps. A number of countries, and particularly European countries, have child product safety regulations, which require that release of the child from the restraint system be accomplished by a one-step actuation. As a result of this, chest clips are not typically used in such countries because the chest clip requires an additional, second, independent step to release the child from the harness.

Instead, harness covers that are fixed to the restraint system are often used in European countries. However, these harness covers make it difficult to grip the harness when loosening the system via a central adjustor on the seat. In addition, a typical harness cover uses only friction only friction to properly position the harness. As a result, such a harness cover is not robust enough to prevent many children from freeing their arms from the harness, which can be a safety concern. Chest clips, when properly used, can specifically address such an issue by using a locking feature to connect the two shoulder straps. Some harness covers include a slot that is intended to allow easier grip of the shoulder straps for loosening the straps.

Even in the Unites States with a system that has a separate buckle assembly and chest clip, requiring a caregiver to perform two separate steps or actions to release their child from the restraint system can be frustrating, time consuming, and sometimes difficult, depending on the circumstances at hand. The two release steps can inhibit easy removal of the child, and particularly under stressful circumstances.

### BRIEF DESCRIPTION OF THE DRAWINGS

Objects, features, and advantages of the present invention will become apparent upon reading the following description in conjunction with the drawing figures, in which:

FIG. 1 shows one example of a child restraint or harness system constructed in accordance with the teachings of the present invention and in a fully latched condition.

FIG. 2 shows a back side of the lap buckle assembly, chest clip, and associated strap segments of the harness system in FIG. 1.

FIG. 3 shows the harness system in FIG. 1 with both the lap buckle assembly and the chest clip in a released condition.

FIGS. 4A, 4B, and 4C show schematic, partial cut-away views of one example of a mechanical release actuator arrangement for the system represented in FIGS. 1-3 and with the harness system components latched, released, and detached, respectively.

FIGS. 5A, 5B, and 5C show schematic, partial cut-away views of one example of an electrical release actuator arrangement for the system represented in FIGS. 1-3 and with the harness system components latched, released, and detached, respectively.

FIG. 6 shows another example in simplified form of a harness system constructed in accordance with the teachings of the present invention and having a fixed connection between the chest clip and the buckle assembly.

### DETAILED DESCRIPTION OF THE DISCLOSURE

The disclosed child restraint or harness system examples solve or improve upon one or more of the above noted and/or other problems and disadvantages with prior art harness systems. Particularly, the disclosed harness systems each require only one release step on the part of the caregiver in order to release a child from the harness system. Each disclosed harness system still provides both the lap buckle assembly at the lap portion of the system and the chest clip function at the shoulder harness portion of the system. In one example, the harness system includes a mechanical cable that connects the buckle assembly with the remote chest clip. The cable actuates the release function on one of the clip or buckle assembly when the release actuator on the other is actuated. In another example, the harness system includes an electronic connection between the buckle assembly and the chest clip. When the release actuator on one of the clip and buckle assembly is actuated manually, the release function on the other device is actuated electronically. In one example, the manual release actuator is on the buckle assembly and in another example the manual actuator is on the chest clip. In either embodiment, manual, independent release capability can be provided on both the chest clip and buckle assembly to be used when necessary. In another example, the chest clip sections can be fixedly connected to components of the buckle assembly so that release of the buckle assembly automatically releases the chest clip.

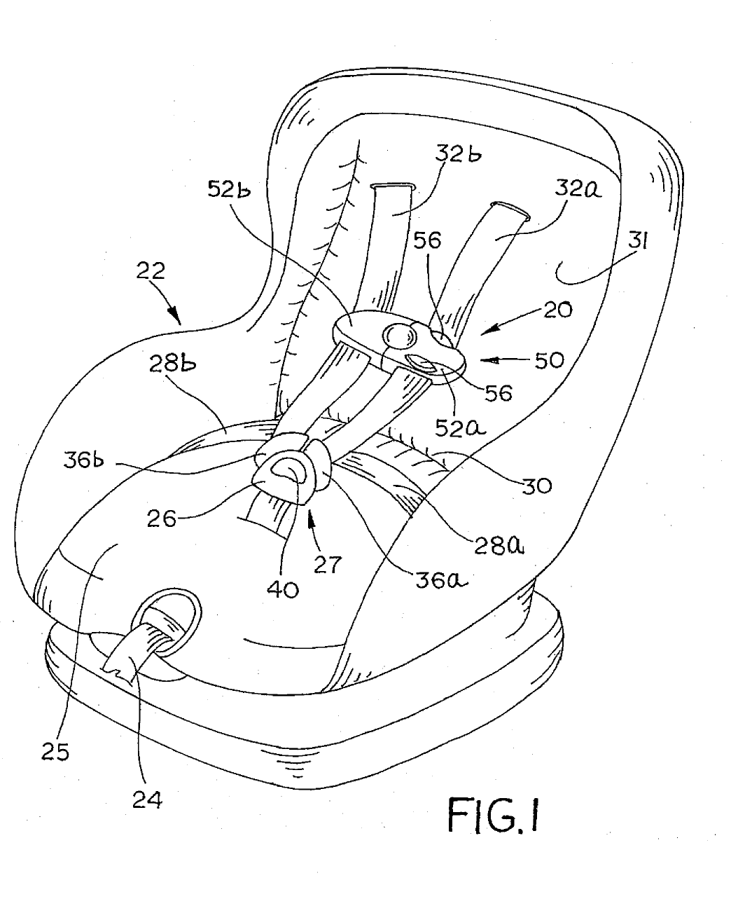

FIG. 1 illustrates one example of a child restraint or harness system 20 on an infant carrier or car seat 22. In this example, the harness system 20 includes a crotch strap 24 extending up from the seat bottom 25 of the carrier 22. A female buckle section or housing 26 of a buckle assembly 27 is connected to a free end of the crotch strap 24. In this example, a left or first lap belt strap 28a extends up and forward from a seat bight 30 between the seat bottom 25 and a seat back 31 of the carrier. Likewise, a right or second lap belt strap 28b extends up and forward from the seat height. A left or first shoulder strap 32a extends up, or in an upward direction, relative to the left lap belt strap 28a and extends through the seat back 31 of the carrier 22 in this example. Likewise, a right or second shoulder strap 32b extends up, or in an upward direction, relative to the right lap belt strap 28b and also extends through the seat back 31.

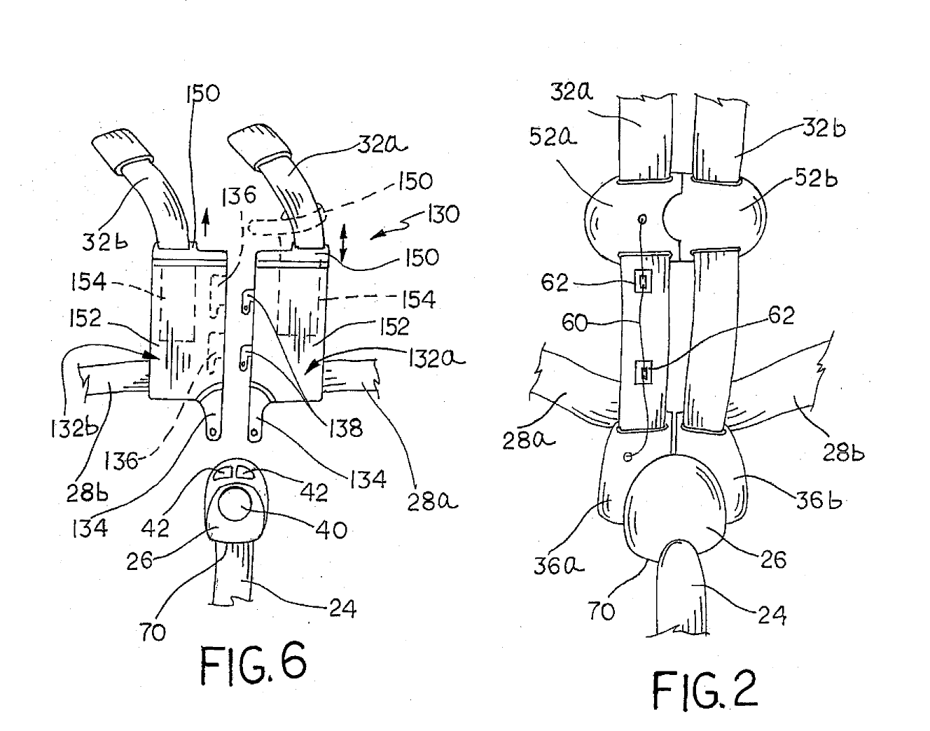

In the disclosed example, a first or left male buckle connector or section 36a is coupled to the left lap belt strap 28a and a male latch prong 38 extends from the buckle section. Similarly, a right or second male buckle connector or section 36b is coupled to the right lap belt 28b and has a male latch prong 38 projecting therefrom. As shown in FIGS. 1 and 2, the female buckle section 26 includes a centrally located release actuator 40 in the form of a button on a front face of the section or housing. As shown in FIG. 2, the male latch prongs 38 can be inserted into female receptacles 42 (best shown in FIGS. 2, 4C, and 5C) in the female buckle section 26 to latch or attach the male buckle sections 36a, 36b to the female buckle section, and thus indirectly to one another. A user need only press the release actuator 40 in order to release the male buckle sections and prongs from the female receptacles 42 in the housing 26.

The above described female buckle housing 26 and male buckle sections 36a, 36b create a buckle assembly in the disclosed example. This buckle assembly 27 can essentially be a standard, conventional configuration and the latching devices and release mechanism can be a standard, conventional configuration and function, other than the modifications as described below. The structure and function of such buckle assembly components are well known and understood in the art and are thus not described in greater detail herein, other than the below-discussed modifications. The male and female aspects of the buckle section 26 and the buckle sections 36a, 36b can be reversed or inverted on the components, if desired.

Also as shown in FIGS. 1 and 2, the harness system 20 in this example employs a chest clip assembly 50. In the disclose example, and on a typical harness system, the left and right shoulder straps 32a, 32b extend upward from the buckle assembly and are generally collateral and adjacent one another. The chest clip assembly 50, when latched, retains a certain spacing between the two shoulder straps 32a, 32b and is vertically slidable along the shoulder straps. The chest clip assembly 50 assists in properly positioning the shoulder straps over the shoulders of a child seated in the carrier 22 and retaining the shoulder straps on the child's shoulders. In this example, the chest clip assembly 50 includes a left or first clip section 52a and a right or second clip section 52b. The two clip sections 52a, 52b are each slidably connected to a respective one of the shoulder straps 32a, 32b. As shown in FIG. 2, the first or left clip section 52a is a female section and the second or right clip section 52b is a male section. The male section 52b in this example includes a pair or resilient latch fingers 54 projecting from one end that faces the female section 52a. The fingers 54 can be inserted into a receptacle (not shown) in the female section 52b when the two clip sections are connected to or engaged with one another.

The chest clip assembly 50 can also be a standard, conventional clip configuration, other than the modifications described below. The fingers 54 can engage the female section's receptacle in a conventional manner as well. The male and female aspects of the two clip sections can be reversed or inverted on the parts as well.

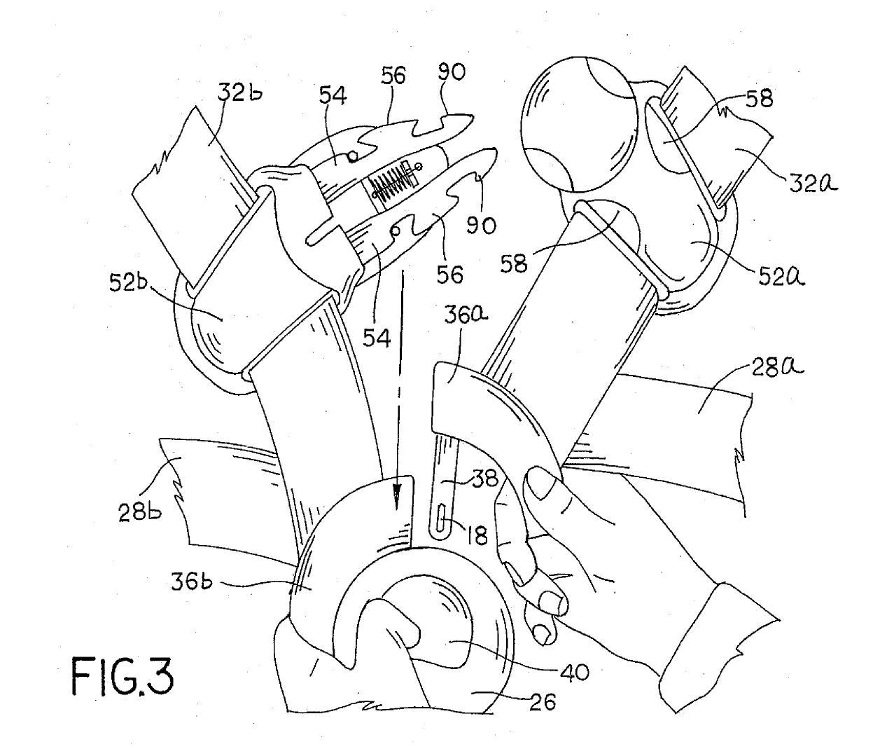

In accordance with the teachings of the present invention, as described in greater detail below, actuation of the actuator 40 automatically releases both the buckle assembly 27 of the lap and shoulder belt straps and the chest clip assembly 50. In other words, when a caregiver actuates the release actuator 40 on the female buckle section 26, the clip sections 52a and 52b of the chest clip assembly 50 automatically disengage from one another and the buckle sections 36a, 36b also detach from the female buckle housing as represented in FIG. 3. As shown in FIGS. 1 and 3, a contact portion or projection 56 on each of the fingers 54 can be exposed through corresponding, oppositely facing openings 58 in the female clip section 52a as is known in the art. If needed, a user can depress the contact portions 56 toward one another to manually disengage the two clip sections 52a, 52b independent of the buckle assembly 27. However, as is described below, the resilient engagement fingers 54 can be automatically actuated upon actuation of the release actuator 40 on the female buckle section 26.

The harness system 20 in the above example is constructed so that the first or left shoulder strap 32a and the first or left lap belt 28a are configured as one continuous or contiguous strap looped through a portion of the male buckle section 36a. Thus, the male buckle section 36a is also slideable along the continuous strap. When latched, the location of the buckle section 36a along the continuous strap will define the separation between the lap belt and shoulder belt strap portions of the continuous strap. The second or right lap and shoulder straps can be identically constructed. The shoulder strap and lap belt on each side can alternatively be separate straps each separately connected to the corresponding buckle section.

In the example of FIGS. 1-3, the chest clip assembly 50 is a completely discreet and separate component from the buckle assembly 27 and yet is actuated simultaneously upon actuation of the buckle assembly's release actuator 40. To accomplish this automatic or simultaneous release, a cable 60 extends between one of the male buckle sections 36a or 36b and the chest clip assembly 50. In this example, the cable 60 is attached to and/or routed along the reverse side of the left or first shoulder strap 32a. One or more fabric loops 62 can be secured or sewn to the strap 32a in this example and the cable 60 can be routed through the loops 62 to retain the cable positioning during use. Also, the cable 60 is not visible when the harness system 20 is latched during use. In general, the disclosed cable 60, through the male buckle section 36a in this example, either mechanically or electrically interconnects the female buckle section or housing 26 to the chest clip assembly 50. The connection is such that actuation of one of the buckle assembly 27 or the chest clip assembly 50 actuates the other. The buckle assembly and chest clip components and the cable 60 can be configured in a variety of ways and use a variety of modes of operation to function as intended to release both the buckle assembly and chest clip upon a single actuation step.

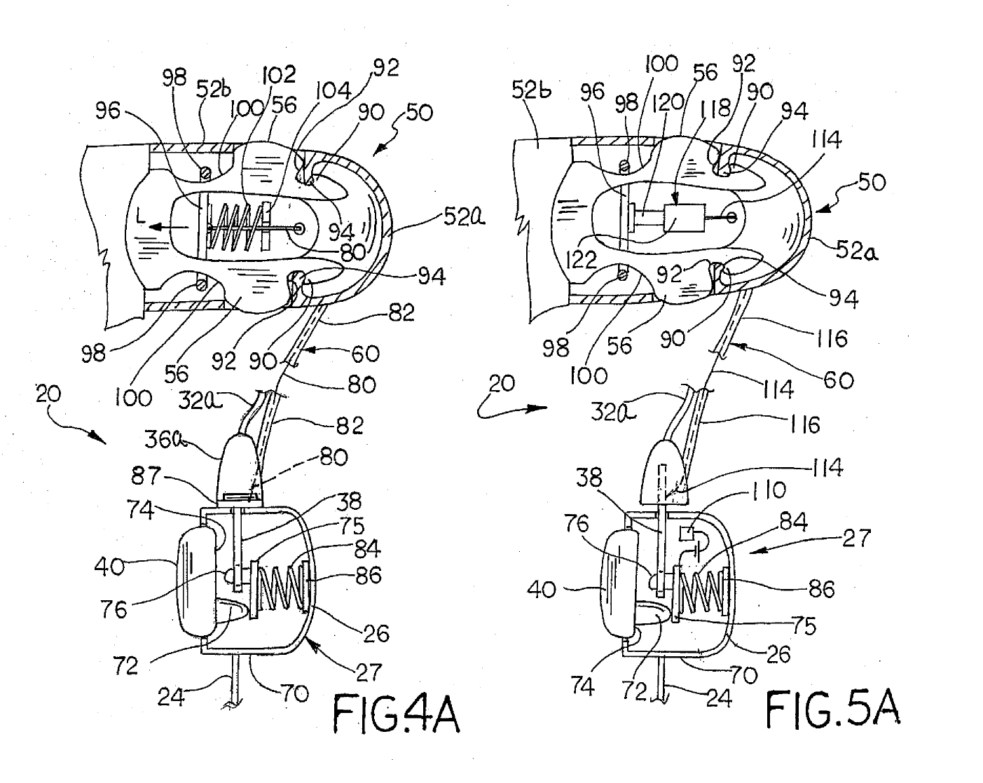

FIGS. 4A-4C schematically show the buckle assembly 27, the housing or female section 26, and the chest clip assembly 50, each modified in accordance with one example of the teachings of the present invention. FIG. 4A shows the harness system 20 in a completely latched configuration. In this example, the buckle assembly 27 is shown in schematic cut-away form with the actuator or button 40 in a latched or engaged position relative to the female buckle housing 26. A portion of the crotch strap 24 extends from the bottom end 70 of the housing 26. A buckle contact 72 projects from the inside surface 74 of the actuator 40. The contact bears against a latch plate 75 schematically shown to have a catch 76 that projects back toward the actuator 40. The catch 76 in this latched configuration is received through an opening 78 in the male prong 38 of the buckle section 36a.

Also as depicted in FIG. 4A, the cable 60 is a mechanical pull-type cable with a wire 80 slidable along and housed within a sheath 82. In this example, the latch plate 75 is biased toward the inside surface 74 of the actuator 40 by a spring 84 that is sandwiched between a spring stop 86 in the housing 26 and the movable latch plate 75. A cable plate 87 is positioned on the end of the male buckle section 36a and defines a cavity between the plate and the end of the section. An end of the wire 80 is fixed to the cable plate 87 within the cavity. A spring 88 is housed within the cavity and biases the cable plate 87 away from the end of the buckle section (best seen in FIGS. 4B and 4C). As further depicted in FIG. 4A, an opposite end of the cable 60 extends from the male buckle section 36a and is connected to the chest clip assembly 50. An opposite end of the wire 80 extends into the female clip section 52b. In this example, the wire 80 is positioned between the fingers 54 of the male clip section 52b, which in this depiction is engaged with the female section 52a.

As schematically shown, each of the flexible fingers 54 generally has a catch portion 90 facing in opposite directions from one another. In this example, an entry 92 to the catch portion 90 is positioned between the catch portion and the corresponding contact portion 56 on each flexible finger. As shown in FIG. 4A, a mating catch projection 94 provided on the female clip section 52a is seated within the entry 92 of each finger and engages the catch portion 90 as known in the art. In this configuration, the male section 52b, including the flexible fingers 54, is engaged with the female section 52a of the chest clip assembly 50. The male section cannot be withdrawn without the flexible fingers 54 being drawn toward one another to release the corresponding catch portions 90 and projections 94, as represented in FIG. 4B. For a conventional chest clip assembly 50, a user would simply depress the contact portions 56 on each of the flexible fingers 54 toward one another to disengage the catch portions 90 and catch projections 94 in order to manually disengage or release the chest clip. In accordance with the teachings of the present invention, when a user depresses the actuator 40 into the female buckle housing 26 as depicted in FIG. 4B, the flexible fingers 54 are automatically drawn toward one another to release the chest clip.

With reference again to FIG. 4A, a slidable yoke 96 has two prongs 98 that capture the flexible fingers 54 therebetween. Each of the flexible fingers 54 has a ramp 100 or wedge surface on opposite facing surfaces of the fingers. Each of the ramps 100 is oriented at an incline moving in the direction of the free end or catch portion 90. In the latched position shown in FIG. 4A, the two prongs 98 of the yoke 96 are positioned at the base of the respective ramps 100. A spring 102 rests against a stop surface 104 provided in the male clip section 52b and biases the yoke 96 to the latched position. The wire 80 is coupled to the yoke 96, pulling the wire in the direction of the bias L of the spring 102 in the latched condition. When latched, cable plate is held close to the end of the buckle section 36a against the force of spring 88 and held in this compressed position by the catch 76. The wire 80 is thus pushed upward by the cable plate 87. However, slack in the wire is taken up by the spring 102 and yoke 96 in the clip assembly 50.

To release the harness system 20, the user need only depress the actuator 40 in the direction of the arrow A. As the user depresses the actuator 40, the contact 72 in this example will push on the latch plate 75 against the bias of the spring 84. This in turn will release the catch 76 from the opening 78 in the male latch prongs 38 (only one being representatively shown in FIGS. 4A-4C). Once released, as depicted in FIG. 4B, the buckle section 36a will pop up away from the housing 26 via the spring 88 on the buckle section, which biases the cable plate 87 away from the buckle section end. The cable plate 87 then pulls the wire 80 in the direction of the arrow P relative to the buckle section, because the sheath 82 is fixed to the buckle section at F. The wire will then pull the yoke 96 against the bias of the spring 102 toward the spring stop 104. This in turn pulls the yoke prongs 98 toward the free ends of the flexible fingers 54 driving the prongs along the surfaces of the ramps 100. In the disclosed example, the prongs 98 are spaced at a fixed distance apart from one another. The movement of the yoke 96 along the ramsps 100 will draw the flexible fingers 54 toward one another to the disengaged or released position of the chest clip shown in FIG. 4B. In this position, the male and female clip sections 52a, 52b can be separated from one another to disengage the chest clip assembly 50 as in FIG. 3. The male buckle sections 36a, 36b can also be separated from the female buckle section or housing 26 in the direction of the arrow R once disengaged as depicted in FIGS. 3 and 4C.

If desired, an additional spring bias can be provided within the chest clip assembly (though not depicted herein) in conjunction with cam surfaces on the flexible fingers or some other surfaces. The additional spring bias and cam surfaces can be configured to automatically separate the two clip sections from one another upon disengagement of the flexible fingers. In one example, the resiliency of the fingers 54 can alone create the separation bias or force upon disengagement of the two sections 52a, 52b. The various components are shown herein in a simplified manner in order to illustrate operation of the mechanisms in this example. The shape, configuration, arrangement, and interaction of the various components can vary considerably from that shown and described herein.

FIGS. 4A and 4B illustrate only one possible example of a mechanical release mechanism or device that can be utilized to transfer motion of the buckle release actuator 40 to simultaneously release the chest clip assembly. As will become evident to those having ordinary skill in the art upon reading this disclosure, other mechanical release mechanisms or devices and arrangements can be utilized within the spirit and scope of the present invention. For example, the operation can be reversed and the spring and cable coupling (plate 88 and plate 87) can be provided on the female chest clip section, such as between the flexible fingers and the pulling end of the wire 80 can be connected to the actuator 40. In such an example, a user can disengage the chest clip assembly by utilizing the contact portions 56 on the flexible fingers 54 and movement of the flexible fingers can result in the wire 80 pulling the actuator 40 to the unlatched positioned depicted in FIG. 4B. In such an embodiment, the manual actuation would be at the chest clip assembly and the automatic actuation is at the buckle assembly, which is the reverse of the example depicted in FIGS. 4A-4C.

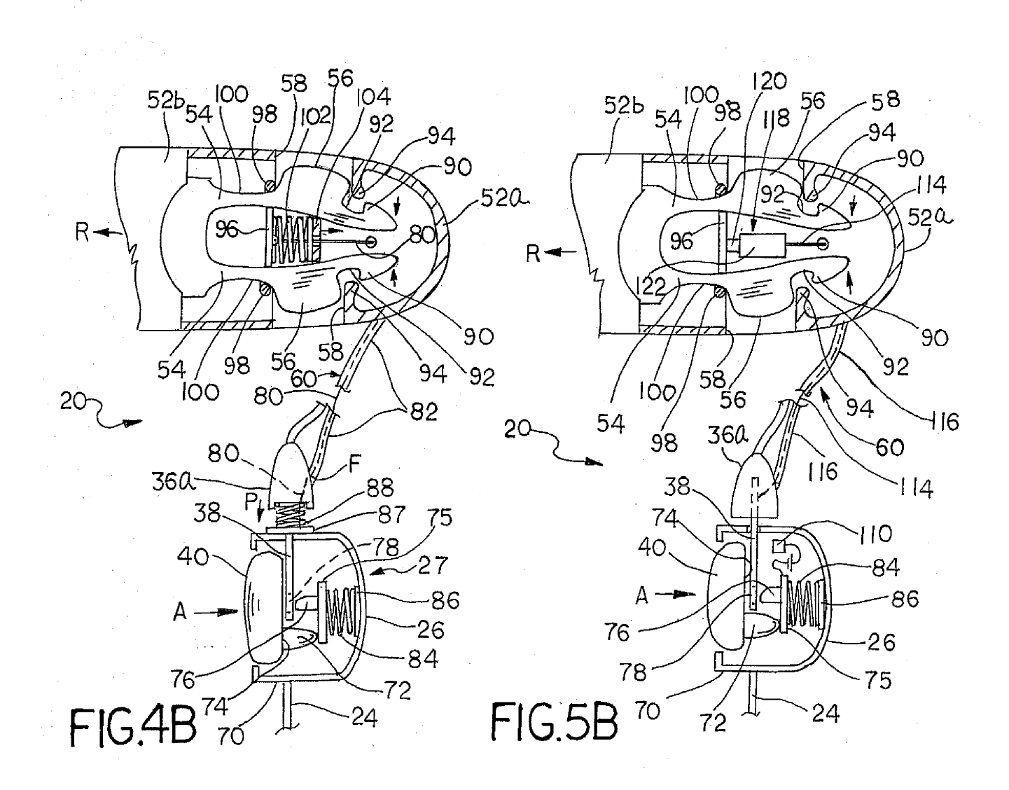

FIGS. 5A-5C show another example of the buckle assembly 27 and the chest clip assembly 50, each modified in accordance with the teachings of the present invention. FIGS. 5A-5C show another example of an automatic release mechanism or device. In this example, the buckle assembly 27 and the chest clip assembly 50 are again schematically depicted or shown in simplified form. The disclosed release mechanism is an electrical device that converts manual actuation of the release actuator 40 to an electrical signal that automatically disengages the chest clip assembly 50. As shown in FIG. 5A, the mechanical contact 72 is again provided on the inside surface 74 of the buckle assembly actuator 40. The contact 72 again bears against the latch plate 75, which is biased toward the actuator inside surface 74 by the spring 84 and stop 86. The buckle section 36a is latched in the same manner as in the prior mechanical example.

In this example, the male prong 38 and catch 76 act as a switch that closes when latched by contact between the two parts within the opening 78. The latch plate 75 can be connected to a battery 110 housed within the buckle section or some other appropriate location and electrically coupled to the catch or latch plate. The male prong 38 in this example is coupled to a wire lead 114, which extends through a sheath 116. The wire lead 114 and sheath 116 in this example form the cable 60′ and are substituted for the mechanical cable including the wire 80 and sheath 82 of the prior example. The electrical cable 60′ in this example can be routed between the buckle assembly 27 and chest clip 50 in the same manner.

Also in this example, a solenoid 118 is positioned within the male clip section 52b between the prongs 54 to replace the previously described spring 102 and spring stop 104. The solenoid 118 has a slidable post or actuator 120 extending from a housing 122 of the solenoid. The free end of the actuator 120 is connected to the yoke 96 in this example. The wire lead 114 is connected to the solenoid 118. When a user depresses the button or actuator 40, the actuator contact 110 again moves the latch plate 75 against the force of the spring 84. The catch will be released from the prong 38 breaking contact and opening the switch. The solenoid can be such that it actuates upon the switch being opened. In this example, actuation of the solenoid withdraws or retracts the post 120 into the housing 122 which in turn pulls the yoke 96 and prongs 98 along the ramp 100 surfaces as described in the prior example. Movement of the yoke 96 in this manner again draws the flexible fingers 54 toward one another to disengage and release the chest clip assembly automatically upon actuation of the buckle assembly actuator 40. The chest clip section 52a and 52b can then be disengaged and separated from one another as shown in FIG. 3. Likewise, the buckle sections 36a and 36b can be disengaged from the female housing 26 as shown in FIGS. 3 and 5C.

As with the previously described mechanical release mechanism embodiment, FIGS, 5A and 5B illustrate only one possible example of an electrical release mechanism or device that can be utilized to transfer motion of the buckle release actuator 40 to simultaneously release the chest clip assembly. As will become evident to those having ordinary skill in the art upon reading this disclosure, other electrical release mechanisms or devices and arrangements can be utilized within the spirit and scope of the present invention. For example, the electrical contacts to open and close the circuit of the mechanism can be provided within the chest clip assembly and the electrical solenoid can be provided within the buckle assembly 27. In such an example, a user can disengage the chest clip assembly by utilizing the flexible finger contact portions 56 whereby movement of the flexible fingers can close the circuit and actuate the solenoid in the buckle assembly to move the actuator 40 to the unlatched position depicted in FIG. 5B. In another example, the circuit, battery, and solenoid can be configured so that a switch closes upon actuation of the actuator. The solenoid can be such that the post 120 moves as in FIG. 5B by closing the switch.

In addition, the various release mechanism or device components disclosed and described above can vary from the examples shown, both in form and function. With respect to function, the devices utilized to draw the flexible fingers toward one another in this example can move in a direction opposite to that depicted in the two examples. Further, it is possible that the flexible fingers operate in a direction opposite to that disclosed herein when engaged. Thus, the surfaces of the flexible fingers that contact the release mechanism can be located differently from the examples shown, such as on the surfaces of the fingers that face one another instead of the surfaces that face in opposite directions relative to one another. With respect to form, other devices and mechanisms can replace the solenoid, wire spool, mechanical wire, yoke, and the like within the spirit and scope of the present invention. In one simple example, the yoke can be replaced by a slidable loop that completely encircles the two flexible fingers.

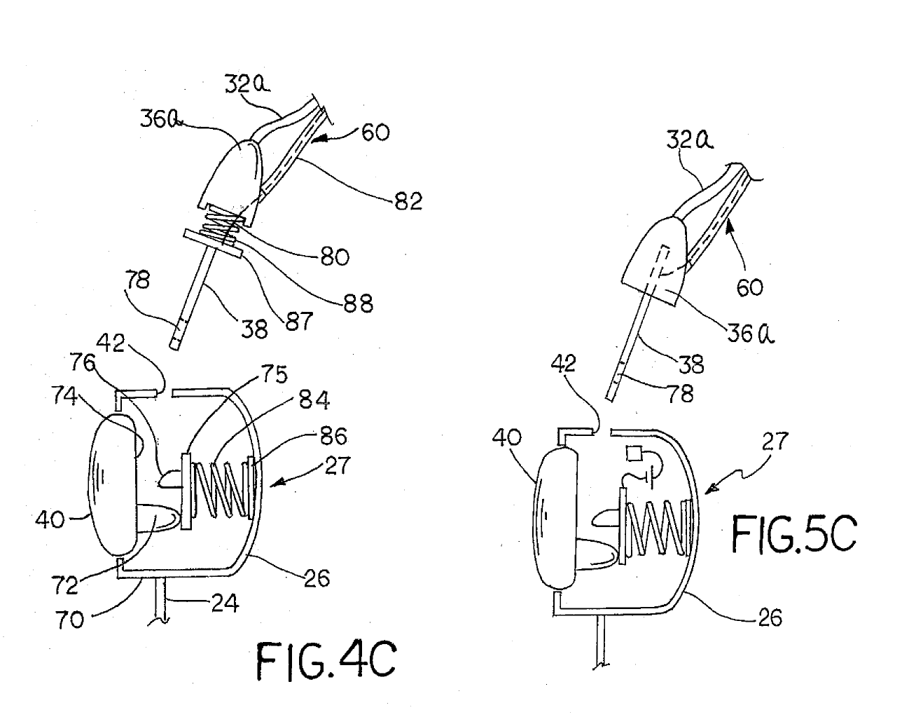

In another example that is substantially different than the two previously discussed examples, the buckle assembly and chest clip can be configured to connect directly to one another and to both automatically disengage upon actuation of a single actuator. To illustrate, FIG. 6 schematically shows a buckle assembly housing section 26 and an alternate chest clip assembly 130. In this example, the male buckle sections 36a, 36b have been eliminated. Instead, the buckle sections and the chest clip are combined into the chest clip assembly 130. The chest clip assembly 130 in this example has a first or left male clip section 132a and a second or right male clip section 132b slidably coupled respectively to the continuous harness straps embodying the lap belt straps 28a, 28b and shoulder straps 32a, 32b as previously described.

In this example, each of the clip sections 132a, 132b is vertically extended to a minimum height suitable for positioning the shoulder straps at the appropriate spaced apart distance at that minimum height. Each of the clip sections 132a, 132b in this example has a male buckle prong 134 projecting downward and connectable to the female housing section 26. One of the clip sections 132a is a female section and in this example has a pair of vertically spaced apart receptacles 136 on a side of the section. The other of the clip sections 132b is a male section and in this example has a pair of corresponding clip prongs 138 projecting from a side of the section. In this example, each of the receptacles 136 and clip prongs 138 is L-shaped. In order to fully latch the hardest system in this example, a user can laterally insert the clip prongs 138 into the clip receptacles 136 and then to move the male clip section 132b downward to connect and engage the two clip sections. The joint clip sections 132a, 132b can then be pushed downward so that the male buckle prongs 134 are received in the female receptacles 42 in the female housing section 26 until the prongs latch.

In order to release or unlatched the hardest system in this example, a user can depress the actuator 40 into the female housing section 26, which will disengage the male buckle prongs 134. The two clip sections 132a, 132b are then free to be disengaged from one another. As mentioned above with respect to the chest clip assembly 50, a spring bias can be provided (though not shown herein) to automatically push the male clip section 132b upward relative to the female clip section 132a to fully disengage the two clip sections without a user having to manually raise the male section relative to the female section. In another example, linear laterally extending male prongs can replace the male clip prongs 138 and merely positionally retain the two clip sections relative to one another when the two clip sections are connected to the female buckle section 26. The buckle assembly and clip sections will remain in a fully latched position in such an example until the actuator 40 is depressed releasing the male buckle prongs 134.

Each of the clip sections 132a, 132b in this example can have an upper loop portion 150 that captures the respective shoulder strap 32a, 32b. The upper loop portion 150 on each of the sections can be vertically adjustable relative to a body 152 of each of the clip sections so as to be capable of positionally adjusting the uppermost height of the chest clip assembly 130 relative to the buckle assembly, and particularly the female buckle housing 26, in this example. Each of the upper loop portions 150 can be connected to a slidable, ratcheting stem 154 that is forcibly movable and, thus, adjustable vertically relative to the respective clip section body 152.

The chest clip sections 132a, 132b can be configured differently from the example shown in and described with respect to FIG. 6. In one example, each clip body can have two sections that can vertically and slidably adjust to alter the height of the upper loop portion 150. This will also in effect change the height of the chest clip assembly 130, while maintaining the physical connection at the bottom of the assembly to the buckle housing 26. Other changes and modifications are within the scope of the present invention.

Although certain harness systems and release mechanisms have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A child seat harness system comprising:
first and second lap belt straps extendable generally toward one another;
a buckle assembly having first and second buckle connectors each coupled to the respective first and second lap belt straps, the buckle assembly positioned and configured to releasably latch the first and second lap belt straps;
a release mechanism on the harness system configured, when actuated, to unlatch the first and second buckle sections at the buckle assembly;
first and second shoulder straps extending collaterally up and away from the buckle assembly; and
a chest clip having two clip sections, one each coupled to a respective one of the first and second shoulder straps, the two clip sections positioned above the buckle assembly and configured to releasably engage one another,
wherein the release mechanism when actuated also disengages the two clip sections from one another.

2. A child seat harness system according to claim 1, wherein the first lap belt strap and the first shoulder strap form a continuous first harness strap segment with the first buckle connector slidable therealong, and wherein the second lap belt strap and the second shoulder strap form a continuous second harness strap segment with the second buckle connector slidable therealong.

3. A child seat harness system according to claim 1, wherein the buckle assembly further comprises a buckle housing carried on a crotch strap and having a pair of receptacles, and wherein the first and second connectors each have a latch prong that can latch within the receptacles.

4. A child seat harness system according to claim 1, wherein the two clip sections are separate and spaced upward from the buckle assembly when the two clip sections are engaged with one another.

5. A child seat harness system according to claim 1, wherein at least one of the two clip sections is directly connected to the buckle assembly when the two clip sections are engaged with one another.

6. A child seat harness system according to claim 1, wherein the release mechanism includes a cable interconnecting the buckle assembly and the chest clip.

7. A child seat harness system according to claim 6, wherein the release mechanism includes an actuator on the buckle assembly configured to disengage via the cable the two clip sections from one another upon actuation of actuator.

8. A child seat harness system according to claim 6, wherein the release mechanism includes an actuator on the chest clip configured to unlatch via the cable the buckle assembly upon actuation of the actuator.

9. A child seat harness system according to claim 6, wherein the cable is a mechanical cable.

10. A child seat harness system according to claim 6, wherein the cable is an electrical cable.

11. A child seat harness system according to claim 1, wherein the release mechanism includes an actuator on the buckle assembly that unlatches the buckle assembly and disengages the chest clip upon manual actuation of the actuator.

12. A child seat harness system according to claim 1, wherein the release mechanism includes an actuator on the chest clip that disengages the chest clip and unlatches the buckle assembly upon manual actuation of the actuator.

13. A child seat harness system according to claim 1, wherein the release mechanism includes a mechanical cable connected to one of the first and second buckle connectors and to one of the two clip sections.

14. A child seat harness system according to claim 1, wherein the release mechanism includes an electrical cable connected to one of the first and second buckle connectors and to one of the two clip sections.

15. A restraint system for a child seat, the restraint system comprising:
a crotch strap extending up relative to a seat bottom of the seat;
a buckle housing carried on the crotch strap;
first and second lap belt straps extending from opposite sides of the car seat;
first and second buckle connectors each coupled to a respective one of the first and second lap belt straps, the buckle connectors releasably attached to the buckle housing when the restraint system is latched;
first and second shoulder straps extending collaterally relative to one another, the first and second shoulder straps each coupled to and extending up and away from a respective one of the buckle connectors;
a chest clip having two clip sections, one each coupled to a respective one of the first and second shoulder straps, the two clip sections positioned above and spaced from the buckle housing and releasably engaged to one another when the restraint system is latched; and
a release mechanism on the buckle housing configured, when actuated, to unlatch the first and second buckle sections from the buckle housing and to also disengage the two clip sections from one another.

16. A restraint system according to claim 15, wherein the first lap belt strap and first shoulder strap form a continuous first harness strap segment with the first buckle connector slidable therealong, and wherein the second lap belt strap and second shoulder strap form a continuous second harness strap segment with the second buckle connector slidable therealong.

17. A restraint system according to claim 15, wherein the release mechanism includes a cable interconnecting the buckle housing and the chest clip.

18. A restraint system according to claim 17, wherein the release mechanism includes an actuator on the buckle housing that, upon actuation, detaches the buckle connectors from the buckle housing and disengages via the cable the two clip sections from one another.

19. A restraint system according to claim 17, wherein the cable is a mechanical cable.

20. A restraint system according to claim 17, wherein the cable is an electrical cable.
